(19) United States
(12) Patent Application Publication
(10) Pub. No.: US 2025/0078395 A1
(43) Pub. Date: Mar. 6, 2025

(54) IMAGE PROCESSING METHOD, APPARATUS, AND ELECTRONIC DEVICE

(71) Applicant: Lenovo (Beijing) Limited, Beijing (CN)

(72) Inventors: Kaiyue CHEN, Beijing (CN); Wanjun LV, Beijing (CN); Jingwei SUN, Beijing (CN); Liuxin ZHANG, Beijing (CN)

(21) Appl. No.: 18/796,401

(22) Filed: Aug. 7, 2024

(30) Foreign Application Priority Data
Aug. 28, 2023 (CN) 202311092182.5

(51) Int. Cl. G06T 15/20; G06T 3/40

(52) U.S. Cl. CPC G06T 15/205; G06T 3/40

(57) ABSTRACT

An image processing method includes: obtaining a first image, the first image being a two-dimensional (2D) image; and processing the first image to obtain a first view and a second view, the first view corresponding to a first viewpoint, the second view corresponding to a second viewpoint, and an image quality of the first view is lower than an image quality of the second view. The first view and the second view are used to achieve three-dimensional (3D) image output.

### CROSS-REFERENCE TO RELATED APPLICATION

This application claims priority to Chinese Patent Application No. 202311092182.5, filed on Aug. 28, 2023, and the entire content of which is incorporated herein by reference.

### TECHNICAL FIELD

The present disclosure relates to the technical field of image processing technology, and more particularly, to an image processing method, an image processing apparatus, and an electronic device.

### BACKGROUND

Naked-eye three-dimensional (3D) imaging refers to: outputting two-dimensional (2D) images as 3D images without the help of external tools such as polarized glasses to achieve a stereoscopic visual effect. For example, based on a 2D image, a left-eye view and a right-eye view are generated, and then the left-eye view and the right-eye view are synthesized to obtain a 3D image.

To provide a user with high definition 3D output, it is often necessary to generate the left-eye view and the right-eye view with high resolution, which results in a large amount of data processing for generating the left-eye view and the right-eye view.

Therefore, a technical solution that can reduce the amount of data processing for naked-eye 3D is urgently needed.

### SUMMARY

One aspect of the present disclosure provides an image processing method. The method includes: obtaining a first image, the first image being a two-dimensional (2D) image; and processing the first image to obtain a first view and a second view, the first view corresponding to a first viewpoint, the second view corresponding to a second viewpoint, and an image quality of the first view being lower than an image quality of the second view. The first view and the second view are used to achieve three-dimensional (3D) image output.

Another aspect of the present disclosure provides an image processing apparatus. The image processing apparatus includes a memory storing a computer program and data generated by operation of the computer program; and a processor coupled to the memory and configured to execute the computer program to perform: obtaining a first image, the first image being a two-dimensional (2D) image; and processing the first image to obtain a first view and a second view, the first view corresponding to a first viewpoint, the second view corresponding to a second viewpoint, and an image quality of the first view being lower than an image quality of the second view. The first view and the second view are used to achieve three-dimensional (3D) image output.

Another aspect of the present disclosure provides an electronic device capable of image processing. The electronic device includes a memory storing a computer program and data generated by operation of the computer program; and a processor coupled to the memory and configured to execute the computer program to perform: obtaining a first image, the first image being a two-dimensional (2D) image; and processing the first image to obtain a first view and a second view, the first view corresponding to a first viewpoint, the second view corresponding to a second viewpoint, and an image quality of the first view being lower than an image quality of the second view. The first view and the second view are used to achieve three-dimensional (3D) image output.

### BRIEF DESCRIPTION OF THE DRAWINGS

To more clearly illustrate the technical solutions in the embodiments of the present disclosure, drawings required for the description of the embodiments are briefly described below. Obviously, the drawings described below are merely some embodiments of the present disclosure. For those skilled in the art, other drawings can be obtained based on these drawings without creative efforts.

FIG. 1 is a flowchart of an image processing method according to some embodiments of the present disclosure;

FIG. 2 is a schematic diagram of outputting a 3D image based on a first view and a second view according to some embodiments of the present disclosure;

FIGS. 3-5 are partial flowcharts of an image processing method according to some embodiments of the present disclosure;

FIG. 6 is a schematic structural diagram of an image processing apparatus according to some embodiments of the present disclosure;

FIG. 7 is a schematic structural diagram of an electronic device according to some embodiments of the present disclosure;

FIG. 8 is a schematic diagram of processing a crosstalk area according to some embodiments of the present disclosure;

FIG. 9 is a schematic diagram of image processing based on depth information according to some embodiments of the present disclosure; and

FIG. 10 is a schematic diagram of outputting a left view and a right view according to some embodiments of the present disclosure.

### DETAILED DESCRIPTION OF THE EMBODIMENTS

To enable those skilled in the art to better understand the technical solutions of the embodiments of the present disclosure, the technical solutions in the embodiments of the present disclosure will be clearly and completely described below in conjunction with the accompanying drawings. Obviously, the described embodiments are merely part of the embodiments of the present disclosure, not all of the embodiments. Based on the embodiments of the present disclosure, all other embodiments obtained by those skilled in the art without creative work are within the scope of the present disclosure.

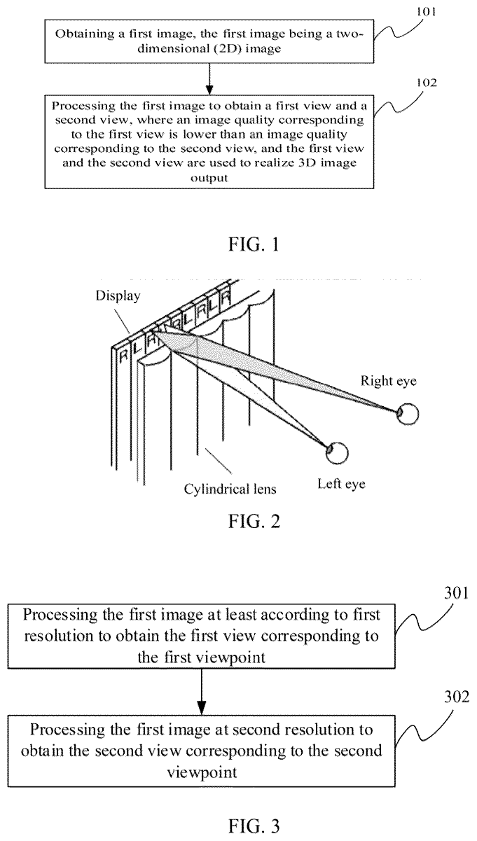

FIG. 1 is a flowchart of an image processing method according to some embodiments of the present disclosure. The method can be applied to electronic devices capable of image processing, such as computers or servers. The technical solution in the embodiment is mainly used to reduce an amount of data processing for three-dimensional (3D) output. As shown in FIG. 1, the method includes the following processes.

At 101, a first image is obtained, the first image being a two-dimensional (2D) image.

The first image is a two-dimensional image that needs to be output in 3D.

In some embodiments, the first image is a 2D image collected by an image acquisition device such as a camera. For example, a scenery picture taken by a user using a mobile phone.

In some other embodiments, the first image is a 2D image generated by an image processing tool. For example, a line drawing such as a cartoon drawn by a user using a drawing tool.

At 102, the first image is processed to obtain a first view and a second view, where an image quality corresponding to the first view is lower than an image quality corresponding to the second view, and the first view and the second view are used to realize 3D image output.

The first view corresponds to a first viewpoint, and the second view corresponds to a second viewpoint. For example, the first view is a view corresponding to a left eye viewpoint, and the second view is a view corresponding to a right eye viewpoint.

In some embodiments, an image resolution of at least some areas in the first view is lower than an image resolution of the second view.

In some other embodiments, an image content of at least some areas in the first view is less than an image content of the corresponding areas in the second view.

For example, as shown in FIG. 2, L is the image content of the left eye view, and R is the image content of the right eye view. Through a cylindrical lens of the display screen, L is output to the left eye viewpoint, and R is output to the right eye viewpoint, thereby achieving a 3D output effect.

In some embodiments, the image quality corresponding to the first view is lower than the image quality corresponding to the second view. For example, the overall image quality of the first view is lower than the overall image quality of the second view. Taking FIG. 2 as an example, the image quality of the overall image content of all L is lower than the image quality of the overall image content of all R. Human brain automatically completes any missing content of one viewpoint based on the content of another viewpoint. Even if the overall image quality of the first view is low, due to the high overall image quality of the second view, when being output to human eyes, the human brain will automatically complete the image content in the first view based on the image content in the second view, without affecting the 3D output effect, and the amount of data processing is reduced in this process.

In some embodiments, the image quality corresponding to the first view is lower than the image quality corresponding to the second view. For example, the image quality of the image area corresponding to the second viewpoint in the first view is lower than the image quality of the image area corresponding to the second viewpoint in the second view. Taking FIG. 2 as an example, the image quality of the image content on the right side of L is lower than the image quality of the image content on the right side of R. The human brain automatically completes the missing content of one viewpoint based on the content of another viewpoint. Even if the image quality is low for the image area at the position corresponding to the second viewpoint in the first view, because the image quality of the image area at the position corresponding to the second viewpoint in the second view is high, when being output to the human eyes, the human brain will automatically complete the image content at the corresponding position in the first view based on the image content at the position corresponding to the second viewpoint in the second view, without affecting the 3D output effect, and the data processing amount is reduced in this process.

It can be seen from the above technical scheme that in an image processing method provided in the embodiments of the present disclosure, when generating views of two viewpoints for a 2D image, the view of one viewpoint is processed at a low quality to reduce the data processing amount of the view. However, due to the perceptual filling principle of the human brain, that is, the human brain will automatically fill in the missing content of another viewpoint based on the content of one viewpoint. Even if the image quality of one viewpoint is reduced in this case, the 3D image output effect will not be deteriorated. Therefore, the present disclosure can reduce the amount of data processing for the 3D output without affecting the 3D output effect.

Further, in the case where the image quality of the image area corresponding to the second viewpoint in the first viewpoint is lower than the image quality of the image area corresponding to the second viewpoint in the second viewpoint, the image quality of the image area corresponding to the first viewpoint in the second viewpoint can also be lower than the image quality of the image area corresponding to the first viewpoint in the first viewpoint. At this time, the overall image quality of the first viewpoint is similar to the overall image quality of the second viewpoint. If the image quality of the image area corresponding to the first viewpoint in the second viewpoint is similar to the image quality of the image area corresponding to the first viewpoint in the first viewpoint, the overall image quality of the first viewpoint is lower than the overall image quality of the second viewpoint. The human brain automatically completes the missing content of one viewpoint based on the content of another viewpoint. Even if the image quality of the image area at the position corresponding to the first viewpoint in the second view is low, because the image quality of the image area at the position corresponding to the first viewpoint in the first view is high, when being output to the human eyes, the human brain will automatically complete the image content at the corresponding position in the second view based on the image content at the position corresponding to the first viewpoint in the first view, without affecting the 3D output effect, and the amount of data processing is reduced in this process.

In some embodiments, when the first image is processed to obtain the first view and the second view at 102, it can be implemented in the following manner, as shown in FIG. 3.

At 301, the first image is processed at least according to first resolution to obtain the first view corresponding to the first viewpoint.

The resolution of at least part of an area in the first view is he first resolution, and the amount of data processing for the first view corresponds to the first resolution.

At 302, the first image is processed at second resolution to obtain the second view corresponding to the second viewpoint.

The resolution of the second view is second resolution, and the amount of data processing for the second view corresponds to the second resolution. The first resolution is lower than the second resolution, such that the amount of data processing for the first view is lower than the amount of data processing for the second view. The human brain automatically completes the missing content of one viewpoint according to the content of another viewpoint. Even if the image resolution of the first view is low, because the image resolution of the second view is relatively high, when being output to the human eyes, the human brain will automatically complete the image content of the first view according to the high-resolution image content in the second view, thereby reducing the amount of data processing while achieving a 3D output effect.

It should be noted that an execution order between 301 and 302 may be as shown in FIG. 3, or 302 may be executed first before 301, or 301 and 302 may be executed simultaneously. Different technical solutions implemented in different execution orders of 301 and 302 are all within the scope of the present disclosure.

In some embodiments, at 301, the first image may be processed first, such as viewpoint image conversion, to obtain the image content corresponding to the first viewpoint, that is, a first initial view, and then all the areas to be processed of the first initial view are processed according to the first resolution, such as rendering and content filling, to obtain the first view with the first resolution, and the resolution of the second view is the second resolution, such that the amount of data processing for the first view is lower than the amount of data processing for the second view, thereby reducing the amount of data processing while achieving the 3D output effect.

In some other embodiments, at 301, the first image may be processed first to obtain the first initial view corresponding to the first viewpoint, and then a first processing area in the first initial view may be processed according to the first resolution, such as rendering and content filling, and at the same time, a second processing area in the first initial view may be processed according to the second resolution, and the first processing area and the second processing area may constitute the first view corresponding to the first viewpoint.

That is, in some embodiments, a part of the area in the first initial view is processed with the lower first resolution, and the other areas in the first initial view are still processed with the higher second resolution, such that the resolution of some areas in the first view is the lower first resolution, the resolution of other parts is the second resolution, and the resolution of the second view is the second resolution, such that the amount of data processing for the first view is lower than that of the second view, thereby reducing the amount of data processing while achieving the 3D output effect.

For example, the first processing area is an area in the first initial view that is at least adjacent to the view corresponding to the second viewpoint. In practical applications, the first processing area is a crosstalk area where crosstalk occurs between the views corresponding to the second viewpoint in the first initial view, and crosstalk occurs between the two views in the adjacent areas of the two views. Based on this, in some embodiments, low-resolution processing is performed on the crosstalk area to reduce the image quality. But when achieving the 3D output effect, because the 3D imaging effect is dominated by the high-resolution second view, the present disclosure reduces the amount of data processing while also reducing the impact of crosstalk.

It should be noted that the crosstalk area is related to hardware configuration of an output device. Based on this, in some embodiments, a crosstalk rate can be determined based on the hardware configuration of the electronic device, and then the crosstalk area can be determined.

Further, in some embodiments, when the first image is processed according to the second resolution to obtain the second view corresponding to the second viewpoint, the first image may be processed first to obtain a second initial view corresponding to the second viewpoint, and then a third processing area in the second initial view is processed according to the first resolution, and a fourth processing area in the second initial view is processed according to the second resolution. The third processing area and the fourth processing area constitute the second viewpoint. At this time, the image quality of the image area corresponding to the second viewpoint in the first viewpoint is lower than the image quality of the image area corresponding to the second viewpoint in the second viewpoint, and the image quality of the image area corresponding to the first viewpoint in the second view is lower than the image quality of the image area corresponding to the first viewpoint in the first view.

In one example, crosstalk usually occurs in an area corresponding to another viewpoint in the current view. Therefore, in addition to causing a crosstalk area in the first initial view where crosstalk occurs between views corresponding to the second viewpoint, the crosstalk area in the second initial view where crosstalk occurs between views corresponding to the first viewpoint may also exist. At this time, in some embodiments, the crosstalk area in the second initial view may be processed with the lower first resolution, and the other areas in the second initial view may still be processed with the higher second resolution, such that the resolution of some areas in the second view obtained is the lower first resolution, and the resolution of other areas is the second resolution. The human brain automatically completes the missing content of another viewpoint according to the content of one viewpoint. For the image area at the position corresponding to the second viewpoint in the first view, even if the image quality is low, because the image quality of the image area at the position corresponding to the second viewpoint in the second view is high, when being output to the human eyes, the human brain will automatically complete the image content at the corresponding position in the first view according to the image content at the position corresponding to the second viewpoint in the second view. For the image area at the position corresponding to the first viewpoint in the second view, even if the image quality is low, because the image quality of the image area at the position corresponding to the first viewpoint in the first view is high, when being output to the human eyes, the human brain will automatically complete the image content at the corresponding position in the second view according to the image content at the position corresponding to the first viewpoint in the first view. Therefore, after the crosstalk areas in the two views are processed at a low resolution, the 3D visual effect of each view at the corresponding viewpoint is not affected, and the amount of data processing can be further reduced.

In another example, the first processing area is a boundary area between a foreground area and a background area in the first initial view. In practical applications, the first processing area is a jagged area in the first initial view. The jagged area exists at the junction of foreground image content and background image content. Based on this, in some embodiments, low-resolution processing is performed on the jagged area to reduce the image quality. But when achieving the 3D output effect, because the 3D imaging effect is dominated by the high-resolution second view, the present disclosure can reduce the amount of data processing while also reducing the impact of crosstalk.

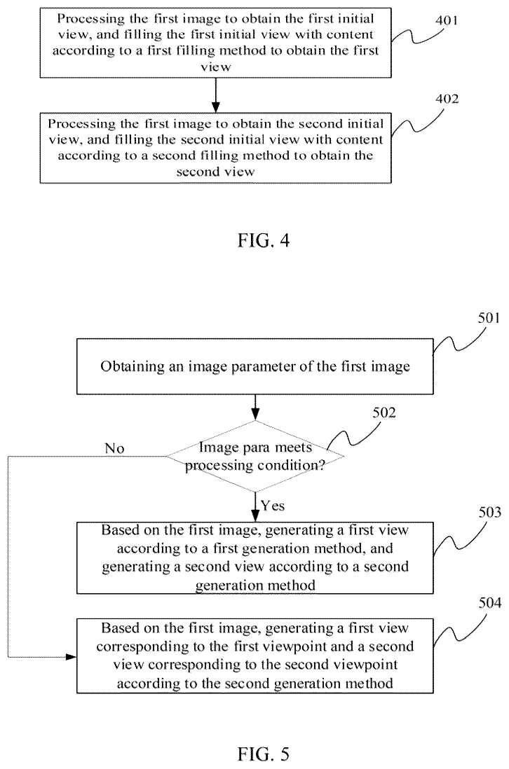

In some embodiments, when the first image is processed to obtain the first view and the second view at 102, it may be implemented in the following manner, as shown in FIG. 4.

At 401, the first image is processed to obtain the first initial view corresponding to the first viewpoint, and the first initial view is filled with content according to a first filling method to obtain the first view.

The first filling method corresponds to a first content filling amount, and the first content filling amount refers to a content filling amount per unit area in the first filling method.

At 402, the first image is processed to obtain the second initial view corresponding to the second viewpoint, and the second initial view is filled with content according to a second filling method to obtain the second view.

The second filling method corresponds to a second content filling amount, and the second content filling amount refers to a content filling amount per unit area in the second filling method. The content filling amount corresponding to the first filling method is less than the content filling amount in the second filling method, such that the amount of data processing for the first view is lower than the amount of data processing for the second view, thereby reducing the amount of data processing while achieving the 3D output effect.

It should be noted that the area to be filled in the first initial view and the second initial view is a missing area between the foreground area and the background area in the first image. To achieve the 3D output effect, it is necessary to fill the missing area between the foreground area and the background area with content. For example, the content of the missing area is filled using pixels of the foreground area and pixels of the background area by means of rasterization or the like.

The execution order between 401 and 402 may be as shown in FIG. 4, or 402 may be executed before 401, or 401 and 402 may be executed simultaneously. The different technical solutions realized by the different execution orders of 401 and 402 are all within the protection scope of the present disclosure.

In some embodiments, the first filling method is a fuzzy filling method, and the second filling method is a realistic filling method. Content details filled in the second filling method are more than content details filled in the first filling method. Based on this, the content details filled in the first view are less than the content details filled in the second view. Therefore, even if the image quality of the first view is reduced by reducing the content details in the first view, the 3D imaging effect is dominated by the high-resolution second view, and the 3D output effect will not be affected, thereby achieving the purpose of reducing the amount of data processing while not affecting the 3D output effect.

In some other embodiments, the first filling method is a filling method that uses different regional pixels to fill the area to be filled in different regions. The second filling method is a filling method that uses multiple regional pixels to fill the area to be filled.

In some embodiments, the pixels of the background area in the first image are used to fill contents in a first filling area in the first initial view according to the first filling method, and the pixels of the foreground area and the background area in the first image are used to fill contents in a second filling area in the first initial view according to the first filling method, thereby obtaining the first view. The pixels of the foreground area and the background area in the first image are used to fill contents in all filling areas in the second initial view according to the second filling method, thereby obtaining the second view

Here, the first filling area and the second filling area constitute the area that needs to be filled in the first initial view.

The first filling area is the boundary area between the foreground area and the background area in the area that needs to be filled in the first initial view. In practical applications, the first filling area is the jagged area in the first initial view. The jagged area exists at the junction of the image content of the foreground area and the image content of the background area. Based on this, in some embodiments, for other areas that need to be filled outside the jagged area, the pixels of the foreground area and the background area are used to fill the content by rasterization or the like. For the jagged area, the pixels of the background area are used to fill. For example, the corresponding pixels are selected from the pixels of the background area to fill the jagged area. In some embodiments, the image content of the foreground area is not increased, and the amount of data processing for filling with the pixels of the background area is significantly lower than the amount of data processing for filling with the pixels of the foreground area and the background area, and implementation complexity is significantly lower. Therefore, even if the image quality of the first view is reduced by reducing the content of the foreground area in the first view, because the 3D imaging effect is dominated by the high-resolution second view, the 3D output effect is not affected, thereby achieving the purpose of reducing the amount of data processing while not affecting the 3D output effect.

In some other embodiments, the first filling method is the filling method that uses different regional pixels to perform fuzzy filling on the area to be filled, and the second filling method is the filling method that uses multiple regional pixels to perform realistic filling on the area to be filled. Based on this, in some embodiments, for the areas that need to be filled in the first initial view except the jagged area, the pixels of the foreground area and the background area are used to fill the details through rasterization and other methods. But for the jagged area, the pixels of the background area in the first image are used to fill the content in a fuzzy filling manner. Therefore, in some embodiments, the details of the content to be filled in the first view can be reduced, the image content in the foreground area can be reduced to eliminate jaggedness, and a filling method with lower complexity is used. Even if the image quality of the first view is reduced, the 3D imaging effect is dominated by the high-resolution second view, and the 3D output effect will not be affected, thereby achieving the purpose of reducing the amount of data processing while not affecting the 3D output effect.

In some embodiments, when the first image is processed at 102 to obtain the first view and the second view, it can be implemented in the following manner, as shown in FIG. 5.

At 501, an image parameter of the first image is obtained.

The image parameter may include at least one of depth parameters, texture parameters, frequency parameters, or attention, etc. The attention refers to the degree of attention of the human eyes to each area in an image. The attention may be identified by a deep learning model.

At 502, whether the image parameter meets a processing condition is determined. If the image parameter meets the processing condition, 503 is executed. If the image parameter does not meet the processing condition, 504 is executed.

At 503, based on the first image, a first view corresponding to the first viewpoint is generated according to a first generation method, and based on the first image, a second view corresponding to the second viewpoint is generated according to a second generation method.

In some embodiments, the first generation method includes: a method of processing with the first resolution, and/or the first filling method. The second generation method corresponds to the first generation method. In the case where the first generation method includes the method of processing with the first resolution, the second generation method includes the method of processing with the second resolution. In the case where the first generation method includes the first filling method, the second generation method includes the second filling method.

The image quality corresponding to the first generation method is less than the image quality corresponding to the second generation method.

At 504, a first view corresponding to the first viewpoint and a second view corresponding to the second viewpoint are generated according to the second generation method based on the first image.

For example, the first generation method includes: processing the first image to obtain the first initial view corresponding to the first viewpoint; then, processing the entire area of the first initial view or only a first processed area in the first initial view according to the first resolution, and filling the first initial view with content according to the first filling method to obtain the first view corresponding to the first viewpoint.

The second generation method includes: processing the first image to obtain the second initial view corresponding to the second viewpoint; then, processing the second initial view according to the second resolution, and filling the second initial view with content according to the second filling method to obtain the second view corresponding to the second viewpoint. As a result, the image quality of the first view is lower than the image quality of the second view.

Taking the image parameter as a depth parameter as an example, the depth parameter represents the image depth detected in the first image. The depth parameter corresponds to a confidence value, and the confidence value represents credibility of a detected image depth. Based on this, the image parameter satisfying the processing condition may include: the confidence value corresponding to the depth parameter being less than or equal to a confidence threshold. That is, when the confidence value of the image depth detected in the first image is low, the image quality of the view of one of the viewpoints is reduced. For example, the entire image area in the first initial view or only an image area with a farther image depth is rendered at a low resolution to obtain the first view. In another example, in the first initial view, the image area with the farther image depth is filled with a content by a fuzzy filling method to obtain the first view, and so on. Therefore, even if the image quality of the view of one of the viewpoints is reduced by reducing the resolution and fuzzy filling, because the 3D imaging effect is dominated by the view of another viewpoint with a higher image quality, it will not affect the 3D output effect, thereby achieving the purpose of reducing the amount of data processing while not affecting the 3D output effect.

Taking the image parameter as attention as an example, the attention represents the degree to which each image area in the first image is paid attention to by the human eyes. Based on this, the attention satisfying the processing condition may include: the attention of some image areas in the first image is less than or equal to an attention threshold. That is, when the attention of some image areas in the first image is low, the image quality of the view of one of the viewpoints is reduced. For example, the image area with low attention in the first initial view is rendered at a low resolution to obtain the first view. In another example, the image area with the low attention in the first initial view is filled with content by fuzzy filling to obtain the first view, and so on. Therefore, even if the image quality of the view of one of the viewpoints is reduced by reducing the resolution and fuzzy filling, because the 3D imaging effect is dominated by the view of another viewpoint with a higher image quality, it will not affect the 3D output effect, thereby achieving the purpose of reducing the amount of data processing while not affecting the 3D output effect.

In some embodiments, in the process of outputting a 3D image, the first content in the first view is output to the first viewpoint through an output device, the second content in the first view is output to the second viewpoint through the output device, and the second view is output to the second viewpoint through the output device.

The first content and the second content constitute the first viewpoint. That is, part of the content in the first view is output to the second viewpoint together with the second view to increase the image content output to the second viewpoint and to reduce the image content output to the first viewpoint. That is, the resolution of the second viewpoint is increased and the resolution of the first viewpoint is reduced. Therefore, by increasing the image resolution of the second viewpoint and reducing the image resolution of the first viewpoint during the output process, the increase in the amount of data processing is limited while achieving a high-resolution 3D output effect. However, because the 3D imaging effect is dominated by the view of the second viewpoint with the higher image quality, reducing the image resolution of the first viewpoint will not affect the 3D output effect, thereby achieving the purpose of reducing the amount of data processing while not affecting the 3D output effect.

In some embodiments, the second content in the first viewpoint is output to the second viewpoint through a cylindrical lens in a display to increase the resolution of the second viewpoint and reduce the resolution of the first viewpoint.

In some embodiments, when the first image is processed at 102 to obtain the first view and the second view, the following processes can be adopted.

A first image generation model is used to process the first image to obtain the first view corresponding to the first viewpoint;

A second image generation model is used to process the first image to obtain the second view corresponding to the second viewpoint;

The first image generation model is trained based on first input samples and first output samples. The first input samples are 2D image samples, and the first output samples are first view samples corresponding to the first viewpoint. The second image generation model is trained based on second input samples and second output samples. The second input samples are 2D image samples, and the second output samples are second view samples corresponding to the second viewpoint. The image quality of the first view sample is lower than the image quality of the second view sample.

It should be noted that the first image generation model and the second image generation model can be models based on deep learning. The 2D image samples in the first input samples and the 2D image samples in the second input samples can be the same image samples or different. Accordingly, the first image generation model and the second image generation model can be trained independently or jointly. For example, the first view samples and the second view samples corresponding to the same 2D image samples are used to jointly train the first image generation model and the second image generation model. In another example, different 2D image samples are used to train the first image generation model and the second image generation model separately.

Therefore, even if a view with a lower image quality is generated by a model with the low image quality, the 3D imaging effect is dominated by the view of another viewpoint with a higher image quality, and the 3D output effect will not be affected, thereby achieving the purpose of reducing the amount of data processing while not affecting the 3D output effect.

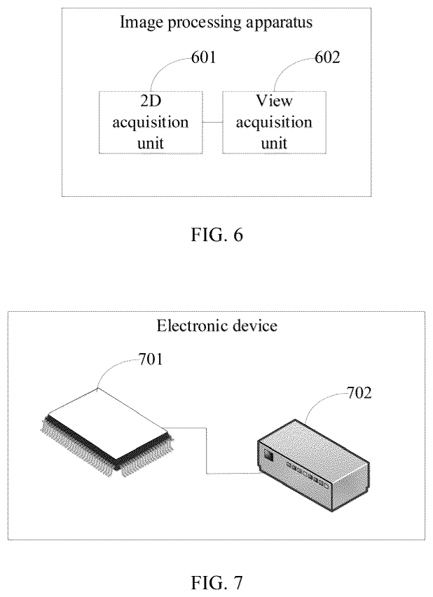

FIG. 6 is a schematic structural diagram of an image processing apparatus according to some embodiments of the present disclosure. The apparatus can be configured in an electronic device capable of image processing, such as a computer or a server. The technical solution in the present disclosure is used to reduce the data processing amount for 3D image output.

As shown in FIG. 6, the apparatus may include a 2D acquisition unit 601 and a view acquisition unit 602. The 2d acquisition unit 601 is used to obtain a first image. The first image is a 2D image. The view acquisition unit 602 is used to process the first image to obtain a first view and a second view. The first view corresponds to a first viewpoint, and the second view corresponds to a second viewpoint. The image quality corresponding to the first view is lower than the image quality corresponding to the second image. The first view and the second view are used to achieve the 3D image output.

It can be seen from the above technical solution that in an image processing apparatus provided in the present disclosure, when generating views of two viewpoints for the 2D image, a view of one viewpoint is processed at a low quality to reduce the data processing amount of the view. However, due to the perceptual filling principle of the human brain, that is, the human brain automatically fills in the missing content of another viewpoint based on the content of one viewpoint. Even if the image quality of one viewpoint is reduced, the effect of the 3D image output will not be deteriorated. Therefore, the amount of data processing for the 3D image output is reduced without affecting the 3D output effect.

In some embodiments, the view acquisition unit 602 is further used to: process the first image at least according to a first resolution to obtain the first view corresponding to the first viewpoint, and process the first image according to a second resolution to obtain the second view corresponding to the second viewpoint. The first resolution is lower than the second resolution.

When the view acquisition unit 602 processes the first image at least according to the first resolution to obtain the first view corresponding to the first viewpoint, it is further used to: process the first image to obtain a first initial view corresponding to the first viewpoint, process a first processing area in the first initial view according to the first resolution, and process a second processing area in the first initial view according to the second resolution. The first processing area and the second processing area constitute the first view corresponding to the first viewpoint.

In some embodiments, the view acquisition unit 602 is further used to: process the first image to obtain a first initial view corresponding to the first viewpoint, fill the first initial view with content according to a first filling method to obtain the first view, process the first image to obtain a second initial view corresponding to the second viewpoint, and fill the second initial view with content according to a second filling method to obtain the second view. A content filling amount corresponding to the first filling method is less than a content filling amount corresponding to the second filling method.

When the view acquisition unit 602 performs content filling on the first initial view according to the first filling method to obtain the first view, it is further used to: perform content filling on the first filling area in the first initial view using pixels of the background area in the first image according to the first filling method, and perform content filling on the second filling area in the first initial view using pixels of the foreground area and the background area in the first image according to the first filling method to obtain the first view. The first filling area and the second filling area constitute the area to be filled in the first initial view.

In some embodiments, the view acquisition unit 602 is further used to: obtain an image parameter of the first image; if the image parameter meets a processing condition, generate the first view corresponding to the first viewpoint according to the first generation method based on the first image, and generate the second view corresponding to the second viewpoint according to the second generation method based on the first image; and if the image parameter does not meet the processing condition, generate the first view corresponding to the first viewpoint and the second view corresponding to the second viewpoint according to the second generation method based on the first image. The image quality corresponding to the first generation method is less than the image quality corresponding to the second generation method.

In some embodiments, a first content in the first view is output to the first viewpoint through an output device, a second content in the first view is output to the second viewpoint through the output device, and the first content and the second content constitute the first view. The second view is output to the second viewpoint through the output device. In some embodiments, the view acquisition unit 602 is further used to: process the first image using a first image generation model to obtain the first view corresponding to the first viewpoint, and process the first image using a second image generation model to obtain the second view corresponding to the second viewpoint. The first image generation model is trained based on first input samples and first output samples, the first input samples are 2D image samples, and the first output samples are first view samples corresponding to the first viewpoint. The second image generation model is trained based on second input samples and second output samples, the second input samples are 2D image samples, and the second output samples are second view samples corresponding to the second viewpoint. The image quality of the first view samples is lower than the image quality of the second view samples. It should be noted that the specific implementation of each unit in the present disclosure can refer to the corresponding previous description, which will not be described in detail herein.

FIG. 7 is a schematic structural diagram of an electronic device according to some embodiments of the present disclosure. As shown in FIG. 7, the electronic device may include a memory 701 and a processor 702. The memory 701 is used to store a computer program and data generated by the operation of the computer program. The processor 702 is used to execute the computer program to perform: obtaining a first image, the first image being a 2D image; and processing the first image to obtain a first view and a second view, the first view corresponding to a first viewpoint, the second view corresponding to a second viewpoint, and an image quality corresponding to the first view is lower than an image quality corresponding to the second view. The first view and the second view are used to achieve 3D image output. In addition, the electronic device may further include an output device, such as a display screen, or the electronic device and the output device may be independently arranged and connected. The output device is used to output the first view and the second view to achieve the 3D image output.

It can be seen from the above technical solution that in the electronic device provided in the present disclosure, when generating views of two viewpoints for the 2D image, the view of one viewpoint is processed at a low image quality to reduce the amount of data processing for the view. However, due to the perceptual filling principle of the human brain, that is, the human brain automatically fills in the missing content of another viewpoint based on the content of one viewpoint, even if the image quality of one viewpoint is reduced, the effect of the 3D image output will not be deteriorated. Therefore, the amount of data processing for the 3D image output is reduced without affecting the 3D output effect.

Taking a display that achieves naked-eye 3D image output as an example, various embodiments of the present disclosure are described below. In some embodiments, the present disclosure provides: according to the principle that the human brain automatically fills in the missing content of another viewpoint based on the content of one viewpoint, a properly low image resolution is used for one of the generated left and right views, or some details are fuzzily filled, which can not only obtain an excellent naked-eye 3D display effect, but also reduce computing power consumption.

Specifically, in the process of generating left and right views, the present disclosure generates a relatively lower resolution view for one of the viewpoints (i.e., the first viewpoint), or uses a simpler filling algorithm to restore a color of an occluded area (i.e., the area that needs to be filled) caused by human eye parallax, without generating complex details, and uses the human brain to automatically complete the content of the other viewpoint, and finally obtains the high-quality naked eye 3D effect.

In some other embodiments, when using artificial intelligence generated content (AIGC) to process 3D left and right view generation tasks, to solve the problem that the image resolution of the view of one of the generated viewpoints is not high enough and the generated details are of low precision, current methods often increase network complexity, and add more complex pre-processing and post-processing, etc., to improve the generated left and right view effects by consuming more computing power. Therefore, the solution with lower resource consumption and almost no effect on the quality of the generated results is needed.

In view of this, the present disclosure provides the following. In the process of generating the left and right views, using an appropriately low resolution for one view (i.e. the first view), or no longer generating high-precision details, significantly reduces computing power consumption, while still obtaining the high-quality naked-eye 3D effect.

For example, in the process of AIGC generating the left and right views, by appropriately reducing the image resolution and content details of one of the viewpoints in the left and right views, the final naked-eye 3D effect will not be affected. Specifically, this can be achieved by using a high-quality generative model and a relatively low-quality generative model, that is, generating the relatively lower resolution view for one of the viewpoints, or replacing the complex network with a lighter-weight network such that no further high-precision detail generation ultimately reduces computing power consumption while still achieving the high-quality 3D effect.

In some other embodiments, a core problem in current naked-eye 3D imaging is related to a crosstalk rate. A high crosstalk rate causes poor visual experience and dizziness, and crosstalk often occurs at edges. In view of this, the present disclosure provides: using the perceptual filling principle of the human brain (that is, to a certain extent, if the image resolution and detail fidelity seen by the two eyes are different, the human brain can form a visual perception of high resolution and detail fidelity through perceptual filling). During the naked-eye 3D imaging, in areas with high crosstalk, the resolution and detail fidelity of the image are reduced, causing the corresponding imaging areas to be dominated by images with high resolution and high-fidelity details, thereby reducing the impact of crosstalk.

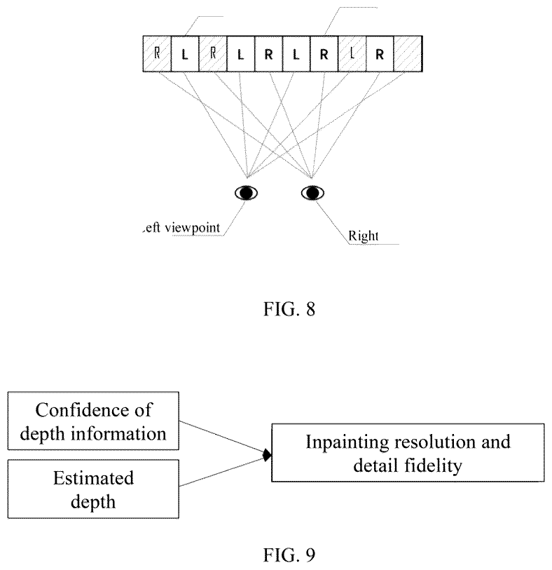

For example, as shown in FIG. 8, the shaded areas represent areas where image resolution is reduced and detail fidelity is reduced. It can be seen that the present disclosure reduces the image resolution and detail fidelity (fuzzy filling) of the image area corresponding to the right viewpoint position in the left view and the image area corresponding to the left viewpoint position in the right view, that is, the area with high crosstalk, such that the amount of data processing for the left and right views is reduced. In this way, under the premise of a given hardware crosstalk rate, the human brain's perceptual filling principle is used to reduce the impact of crosstalk, and the computing power consumption requirements for content rendering are actually reduced.

In some other embodiments, a new perspective generation method is used in the naked-eye 3D imaging. The process may include the following processes. Depth information is first generated based on a 2D image. Areas that need inpainting (filled) are determined based on the depth information. Then, the inpainting is performed. If the depth information is generated inaccurately, errors may be amplified at a later stage, affecting the 3D imaging effect.

FIG. 9 is a schematic diagram of image processing based on depth information according to some embodiments of the present disclosure. The perceptual filling principle of the human brain is applied. When there is little confidence in the judgment of depth information, the resolution and fidelity of the corresponding inpainting can be reduced according to the depth information, such that the human eyes can focus on the corresponding areas. The perception is dominated by the original 2D image, and the 3D image effect is better. The human eyes do not pay much attention to areas where an estimated depth of the image is far away, and the resolution and detail fidelity of inpainting may be reduced to save computing power. It can be seen that the present disclosure improves the 3D visual perception effect while saving computing power.

In some other embodiments, the naked-eye 3D imaging method includes projecting images of different areas on a screen to the left and right eyes of a user through gratings, lenses, etc., such that the images seen by the left and right eyes of the user are images with parallax, thereby forming a stereoscopic vision. Through this method, the resolution experienced by each eye is only half of the screen. If the screen is 8k, each eye can only see 4k.

The present disclosure uses the perceptual filling principle of the human brain to change the naked-eye 3D grating, lens, and other methods from evenly distributing the resolution to the left and right eyes to uneven distribution (such as 2:1). The resolution of the formed stereoscopic vision is not reduced by 50%, but only by 33%.

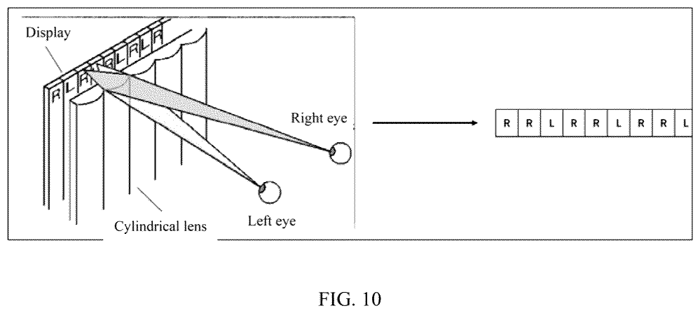

FIG. 10 is a schematic diagram of outputting a left view and a right view according to some embodiments of the present disclosure. As shown in FIG. 10, the structure of the lens is improved, such that the right eye can see more pixel content, thereby maximizing a perceived 3D resolution under a given screen resolution.

In addition, the present disclosure may also be applied to multi-view naked-eye 3D imaging.

In some other embodiments, a view of a new viewpoint is generated for a 2D image by a rasterization method, but due to the principle of rasterization, views from different viewpoints may have jagged edges at each boundary.

In view of this, the present disclosure provides: using the perceptual filling principle of the human brain to eliminate a jagged portion at the junction of a subject and a background. For example, by filling the jagged portion with a background color. It does not affect the naked-eye 3D effect, and it does not increase the details the subject, which solves the problem of decreased 3D effect caused by the inconsistency of the left and right viewpoints.

In the specification, each embodiment is described in a progressive manner, and each embodiment focuses on the differences from other embodiments. The same and similar parts between different embodiments can be referred to each other. For the apparatus disclosed in the present disclosure, because it corresponds to the method disclosed in the present disclosure, the description is relatively simple, and the relevant parts can be referred to the method description.

Professionals may further realize that the units and algorithm steps of each example described in conjunction with the embodiments disclosed herein can be implemented by electronic hardware, computer software, or a combination thereof. To clearly illustrate the interchangeability of hardware and software, the composition and steps of each embodiment have been generally described in the above description according to the function. Whether these functions are performed in hardware or software depends on the specific application and design constraints of the technical solution. Professional and technical personnel may use different methods to implement the described functions for each specific embodiment, but such implementation should not be considered to be beyond the scope of the present disclosure.

The steps of the method or algorithm described in conjunction with the embodiments disclosed herein can be directly implemented by hardware, software modules executed by a processor, or a combination thereof. The software module can be placed in a random-access memory (RAM), a memory, a read-only memory (ROM), an electrically programmable ROM, an electrically erasable programmable ROM, a register, a hard disk, a removable disk, a CD-ROM, or any other form of storage medium known in the technical field.

The above description of the disclosed embodiments enables professional and technical personnel in this field to implement or use the present disclosure. Various modifications to these embodiments will be apparent to those skilled in the art, and the general principles defined herein may be implemented in other embodiments without departing from the spirit or scope of the present disclosure. Therefore, the present disclosure will not be limited to the embodiments shown herein, but will conform to the broadest scope consistent with the principles and novel features disclosed herein.

What is claimed is:

1. An image processing method, comprising:
obtaining a first image, the first image being a two-dimensional (2D) image; and
processing the first image to obtain a first view and a second view, the first view corresponding to a first viewpoint, the second view corresponding to a second viewpoint, and an image quality of the first view being lower than an image quality of the second view;
wherein the first view and the second view are used to achieve three-dimensional (3D) image output.

2. The method according to claim 1, wherein processing the first image to obtain the first view and the second view further comprises:
at least according to a first resolution, processing the first image to obtain the first view corresponding to the first viewpoint; and
according to a second resolution, processing the first image to obtain the second view corresponding to the second viewpoint;
wherein the first resolution is lower than the second resolution.

3. The method according to claim 2, wherein processing the first image at least according to the first resolution to obtain the first view corresponding to the first viewpoint further comprises:
processing the first image to obtain a first initial view corresponding to the first viewpoint;
processing a first processing area in the first initial view according to the first resolution; and
processing a second processing area in the first initial view according to the second resolution;
wherein the first processing area and the second processing area constitute the first view corresponding to the first viewpoint.

4. The method according to claim 1, wherein processing the first image to obtain the first view and the second view further comprises:
processing the first image to obtain a first initial view corresponding to the first viewpoint, and filling the first initial view with content according to a first filling method to obtain the first view; and
processing the first image to obtain a second initial view corresponding to the second viewpoint, and filling the second initial view with content according to a second filling method to obtain the second view;
wherein a content filling amount corresponding to the first filling method is less than a content filling amount corresponding to the second filling method.

5. The method according to claim 4, wherein filling the first initial view with content according to the first filling method to obtain the first view further comprises:
according to the first filling method, filling a first filling area in the first initial view with content using pixels of a background area in the first image; and
according to the first filling method, filling a second filling area in the first initial view with content using pixels of a foreground area and the background area in the first image to obtain the first view;
wherein the first filling area and the second filling area constitute an area to be filled in the first initial view.

6. The method according to claim 1, wherein processing the first image to obtain the first view and the second view further comprises:
obtaining an image parameter of the first image;
when the image parameter meets a processing condition, generating the first view corresponding to the first viewpoint according to a first generation method based on the first image, and generating the second view corresponding to the second viewpoint according to a second generation method based on the first image; and
when the image parameter does not meet the processing condition, generating the first view corresponding to the first viewpoint and the second view corresponding to the second viewpoint according to the second generation method based on the first image;
wherein an image quality corresponding to the first generation method is less than an image quality corresponding to the second generation method.

7. The method according to claim 1, wherein:
a first content in the first view is output to the first viewpoint through an output device, a second content in the first view is output to the second viewpoint through the output device, and the first content and the second content constitute the first view; and
the second view is output to the second viewpoint through the output device.

8. The method according to claim 1, wherein processing the first image to obtain the first view and the second view further comprises:
processing the first image using a first image generation model to obtain the first view corresponding to the first viewpoint; and
processing the first image using a second image generation model to obtain the second view corresponding to the second viewpoint;
wherein:
the first image generation model is trained based on first input samples and first output samples, the first input samples are 2D image samples, and the first output samples are first view samples corresponding to the first viewpoint;
the second image generation model is trained based on second input samples and second output samples, the second input samples are 2D image samples, and the second output samples are second view samples corresponding to the second viewpoint; and
an image quality of the first view samples is lower than an image quality of the second view samples.

9. An image processing apparatus, comprising:
a memory storing a computer program and data generated by operation of the computer program; and
a processor coupled to the memory and configured to execute the computer program to perform:
obtaining a first image, the first image being a two-dimensional (2D) image; and
processing the first image to obtain a first view and a second view, the first view corresponding to a first viewpoint, the second view corresponding to a second viewpoint, and an image quality of the first view being lower than an image quality of the second view;
wherein the first view and the second view are used to achieve three-dimensional (3D) image output.

10. The apparatus according to claim 9, wherein when processing the first image to obtain the first view and the second view, the processor is further configured to perform:
at least according to a first resolution, processing the first image to obtain the first view corresponding to the first viewpoint; and
according to a second resolution, processing the first image to obtain the second view corresponding to the second viewpoint;
wherein the first resolution is lower than the second resolution.

11. The apparatus according to claim 10, wherein when processing the first image at least according to the first resolution to obtain the first view corresponding to the first viewpoint, the processor is further configured to perform:
processing the first image to obtain a first initial view corresponding to the first viewpoint;
processing a first processing area in the first initial view according to the first resolution; and
processing a second processing area in the first initial view according to the second resolution;
wherein the first processing area and the second processing area constitute the first view corresponding to the first viewpoint.

12. The apparatus according to claim 9, wherein when processing the first image to obtain the first view and the second view, the processor is further configured to perform:
processing the first image to obtain a first initial view corresponding to the first viewpoint, and filling the first initial view with content according to a first filling method to obtain the first view; and
processing the first image to obtain a second initial view corresponding to the second viewpoint, and filling the second initial view with content according to a second filling method to obtain the second view;
wherein a content filling amount corresponding to the first filling method is less than a content filling amount corresponding to the second filling method.

13. The apparatus according to claim 12, wherein when filling the first initial view with content according to the first filling method to obtain the first view, the processor is further configured to perform:
according to the first filling method, filling a first filling area in the first initial view with content using pixels of a background area in the first image; and
according to the first filling method, filling a second filling area in the first initial view with content using pixels of a foreground area and the background area in the first image to obtain the first view;
wherein the first filling area and the second filling area constitute an area to be filled in the first initial view.

14. The apparatus according to claim 9, wherein when processing the first image to obtain the first view and the second view, the processor is further configured to perform:
obtaining an image parameter of the first image;
when the image parameter meets a processing condition, generating the first view corresponding to the first viewpoint according to a first generation method based on the first image, and generating the second view corresponding to the second viewpoint according to a second generation method based on the first image; and
when the image parameter does not meet the processing condition, generating the first view corresponding to the first viewpoint and the second view corresponding to the second viewpoint according to the second generation method based on the first image;
wherein an image quality corresponding to the first generation method is less than an image quality corresponding to the second generation method.

15. The apparatus according to claim 9, wherein:
a first content in the first view is output to the first viewpoint through an output device, a second content in the first view is output to the second viewpoint through the output device, and the first content and the second content constitute the first view; and
the second view is output to the second viewpoint through the output device.

16. The apparatus according to claim 9, wherein when processing the first image to obtain the first view and the second view, the processor is further configured to perform:
processing the first image using a first image generation model to obtain the first view corresponding to the first viewpoint; and
processing the first image using a second image generation model to obtain the second view corresponding to the second viewpoint;
wherein:
the first image generation model is trained based on first input samples and first output samples, the first input samples are 2D image samples, and the first output samples are first view samples corresponding to the first viewpoint;
the second image generation model is trained based on second input samples and second output samples, the second input samples are 2D image samples, and the second output samples are second view samples corresponding to the second viewpoint; and
an image quality of the first view samples is lower than an image quality of the second view samples.

17. An electronic device capable of image processing, comprising:
a memory storing a computer program and data generated by operation of the computer program; and
a processor coupled to the memory and configured to execute the computer program to perform:
obtaining a first image, the first image being a two-dimensional (2D) image; and
processing the first image to obtain a first view and a second view, the first view corresponding to a first viewpoint, the second view corresponding to a second viewpoint, and an image quality of the first view being lower than an image quality of the second view;
wherein the first view and the second view are used to achieve three-dimensional (3D) image output.

18. The electronic device according to claim 17, wherein when processing the first image to obtain the first view and the second view, the processor is further configured to perform:
at least according to a first resolution, processing the first image to obtain the first view corresponding to the first viewpoint; and
according to a second resolution, processing the first image to obtain the second view corresponding to the second viewpoint;
wherein the first resolution is lower than the second resolution.

19. The electronic device according to claim 18, wherein when processing the first image at least according to the first resolution to obtain the first view corresponding to the first viewpoint, the processor is further configured to perform:
processing the first image to obtain a first initial view corresponding to the first viewpoint;
processing a first processing area in the first initial view according to the first resolution; and
processing a second processing area in the first initial view according to the second resolution;
wherein the first processing area and the second processing area constitute the first view corresponding to the first viewpoint.

20. The electronic device according to claim 17, wherein when processing the first image to obtain the first view and the second view, the processor is further configured to perform:
processing the first image to obtain a first initial view corresponding to the first viewpoint, and filling the first initial view with content according to a first filling method to obtain the first view; and
processing the first image to obtain a second initial view corresponding to the second viewpoint, and filling the second initial view with content according to a second filling method to obtain the second view;
wherein a content filling amount corresponding to the first filling method is less than a content filling amount corresponding to the second filling method.
